(19) United States
(12) Patent Application Publication
(10) Pub. No.: US 2009/0323973 A1
(43) Pub. Date: Dec. 31, 2009

(54) SELECTING AN AUDIO DEVICE FOR USE

(75) Inventor: Adam R. Dyba, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 12/145,815

(22) Filed: Jun. 25, 2008

(51) Int. Cl. H04R 29/00; H02B 1/00

(52) U.S. Cl. 381/58; 381/123; 381/71.1

(57) ABSTRACT

Selecting for use an audio input device such as a microphone based on the quality of sound sampled from multiple available input devices. The sample is analyzed to determine a background sound level and a peak deviation level above the background. That device having the greatest deviation above the background is selected and all other input devices deactivated. The selection process may also require that the peak value meet or exceed some threshold value in order to be considered. The sampling may occur starting with system activation or may occur prior to activation with selection occurring after system activation.

### BACKGROUND

Telephones, computers, and other electronic systems often have more than one audio input device. This device may or may not be paired with an audio output device such as a speaker. In the case of a telephone, the input and output device may be paired in a handset, headset, or wireless headset.

Where multiple input devices are available the system typically provides a mechanism to select which device to use. This may be a manual selection by the user or a predetermined selection based on a configuration choice.

While these selections may often be correct, they may also be incorrect. As an example, a telephone user who is wearing a wireless headset answers an incoming call by pressing a button on the telephone base unit out of habit. This action is configured to route the audio through the speaker and microphone on the base even though the wireless headset would provide superior sound quality.

Similarly, a computer equipped with a webcam may have an auxiliary microphone plugged in to an input jack. While setting up for an online meeting the user selects the auxiliary microphone as the input device. However, when the meeting starts they leave the microphone laying on the table and speak into the microphone adjacent to the camera attached to the computer screen.

The user's experience would be improved through a process which selects the input device which provides the best sound quality. Selectively disabling input and output devices would also save power, especially where the devices, or perhaps the entire system, are battery powered.

### SUMMARY

This Summary is provided to introduce in a simplified form a selection of concepts that are further described below in the Detailed Description. This Summary is not intended to identify key features or essential features of the claimed subject matter, nor is it intended to be used to limit the scope of the claimed subject matter.

Various aspects of the subject matter disclosed herein are related to selecting one of several audio input devices such as microphones to be used by a system. The selection is based on superior relative performance as determined by comparing peak variations in sound level above the background sound level.

Other aspects relate to applying a threshold level to all peak variation values and considering only those which exceed the threshold value.

The approach described below may be implemented as a computer process, a computing system or as an article of manufacture such as a computer program product. The computer program product may be a computer storage medium readable by a computer system and encoding a computer program of instructions for executing a computer process. The computer program product may also be a propagated signal on a carrier readable by a computing system and encoding a computer program of instructions for executing a computer process.

A more complete appreciation of the above summary can be obtained by reference to the accompanying drawings, which are briefly summarized below, to the following detailed description of present embodiments, and to the appended claims.

### BRIEF DESCRIPTION OF THE SEVERAL VIEWS OF THE DRAWINGS

FIG. 1 is a block diagram of a telephonic device having a wired handset and a wireless headset.

FIG. 2 is a block diagram of an audio system having two microphones.

FIG. 3 is an illustration of a first audio sample.

FIG. 4 is an illustration of a second audio sample.

FIG. 5 is an illustration of a third audio sample.

FIG. 6 is a flowchart of the process of selecting an input device.

### DETAILED DESCRIPTION

This detailed description is made with reference to the accompanying drawings, which form a part hereof, and which show, by way of illustration, specific exemplary embodiments. These embodiments are described in sufficient detail to enable those skilled in the art to practice what is taught below, and it is to be understood that other embodiments may be utilized and that logical, mechanical, electrical, and other changes may be made without departing from the spirit or scope of the subject matter. The following detailed description is, therefore, not to be taken in a limiting sense, and its scope is defined only by the appended claims.

### Overview

The concepts of the present invention pertain to automatically selecting an audio input device, and optionally an associated audio output device, for use based on determining which of multiple input devices available provides the best reception of the user by sampling and comparing the input on all available input devices. A first exemplary embodiment is a cellular telephone having the built-in microphone and a wireless BlueTooth® headset. A second exemplary embodiment is a hands free telephone or intercom system in a building which has multiple microphones. A third exemplary embodiment is a computer based video conferencing system having multiple microphones. The concepts are also applicable to other systems having more than one available audio input device.

Benefits of the system include improved user experience by utilizing the device with the best audio quality and reduced power consumption and reduced noise by deactivating devices which are not needed.

### Structure

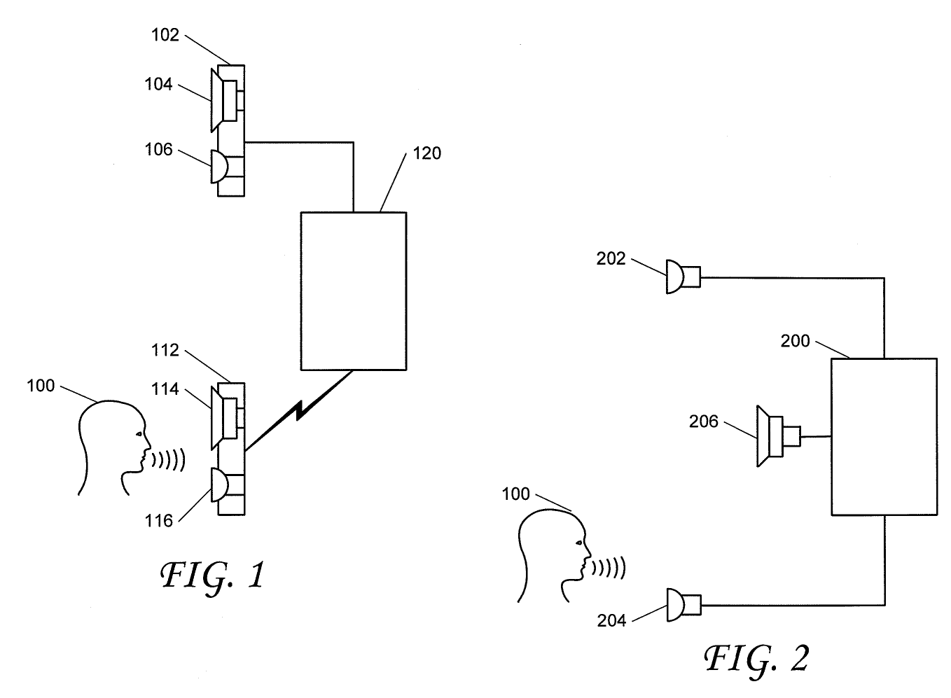

FIG. 1 presents a simplified block diagram of a system 120 having two separate pairs of audio input and output devices. An exemplary embodiment is a cellular telephone. Element 102 represents the built-in handset having a speaker 104 and microphone 106. Element 112 represents a wireless headset having speaker 114 and microphone 116. Representative embodiments allow an incoming call to be answered with either the built-in handset 102 or the wireless headset 112. In some embodiments, the call is automatically routed to the wireless headset 112 if it has been activated. This is disadvantageous where the headset has been set down while still activated or accidentally activated by the user.

FIG. 2 illustrates a hands-free system 200 such as a telephone or intercom system in a house or office. An exemplary system has two or more microphones 202, 204 in different locations and one or more speakers 206 which may be located with the microphones or which may be separately positioned. Any or all of these components may be either wired or wireless. A second exemplary embodiment of a system as shown in FIG. 2 is a hands-free cellular phone system in a car which uses a supplementary microphone and routes the audio output through the radio speakers. In both systems a user 100 who is speaking is the source of audio input to the system. Clearly the system would also be applicable to any other relevant audio source.

The concepts of the present disclosure apply in substantially the same manner to systems of the type shown in either FIG. 1 or FIG. 2. For clarity of discussion the system of FIG. 1 will be used as the basis of the following discussion with the understanding that the discussion is also applicable to systems of the type illustrated in FIG. 2 as well as other systems having the necessary components.

### Operation

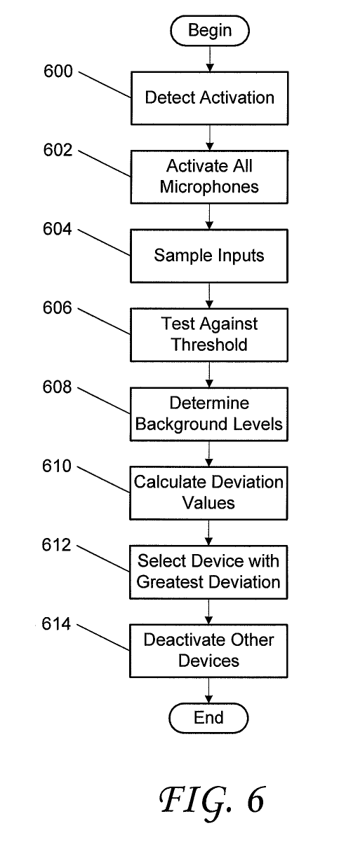

FIG. 6 illustrates the steps in an exemplary embodiment of the process used to select a microphone according to the present disclosure. The process begins at step 600 when activation of the system is detected. For a telephone system this may be lifting the handset to place or accept a call; activating a wireless headset to place or accept a call; pressing a speed-dial button; or any similar action which indicates that the user is about to use the system.

Upon system activation, all available microphones are activated 602. In an exemplary system such as illustrated in FIG. 1 this would include the built-in microphone 106 and the wireless headset microphone 116. With the microphones activated, audio input is sampled 604 from each available device for a short interval. In an exemplary embodiment, the duration of this interval is fixed although different periods may be used for incoming and outgoing calls. Another exemplary embodiment uses a variable duration which terminates when sufficient sampling has occurred to make the selection. This time period may be limited to a predetermined maximum time. In the case of answering a phone call, a representative time period is that which is sufficient to answer the call and speak a greeting such as “Hello.” A representative time for placing a call would be longer since the user would typically not speak until the receiving party answers.

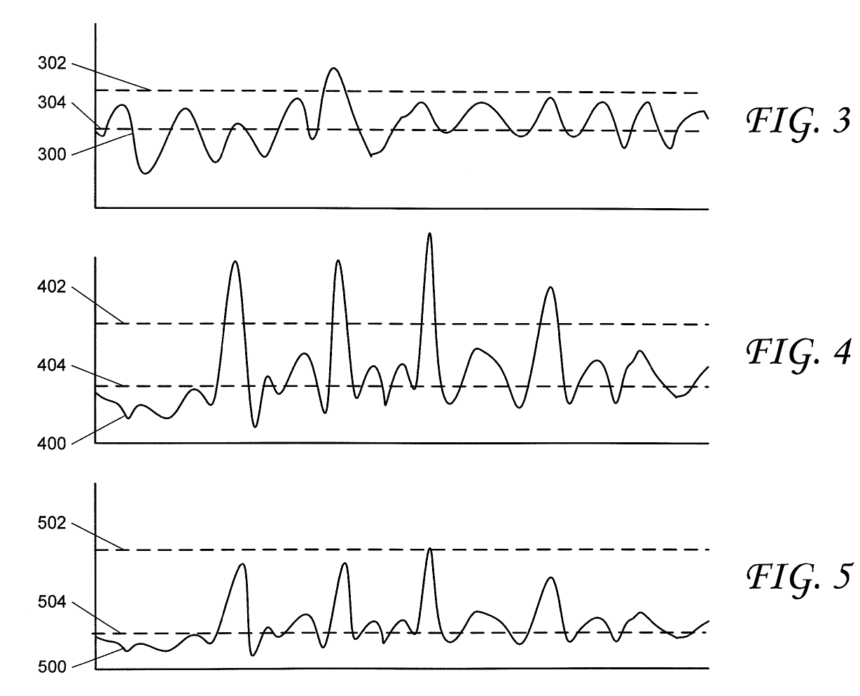

During the sampling period, the amplitude of the audio input signal is sensed accumulating data such as that illustrated graphically in FIG. 3, FIG. 4 and FIG. 5. In these figures, FIG. 4 illustrates the input sampled from the microphone nearest the user 100 and FIG. 3 illustrates the input sampled from a microphone which is further from the user 100. Lines 300, 400 and 500 represent the audio level as it varies with time. In FIG. 3 the audio level 300 remains substantially constant with minor variations which are consistent with environmental background noise. In FIG. 4 the audio level 400 shows peak levels significantly above the background noise. This type of data is consistent with a person speaking in proximity to the microphone. In FIG. 5 the audio level 500 shows peak levels significantly above the background noise but with relatively small absolute amplitude. Dashed Lines 304, 404 and 504 represent individually calculated average background noise values for each microphone.

Dashed Lines 302, 402, and 502 represent a threshold value used to evaluate the sample data. An exemplary embodiment uses the threshold as an additional criteria in selecting the input device. The model underlying the present disclosure is that where a microphone is capturing spoken audio from a user 100 in close proximity, that audio input will show significant power deviations above the background noise, similar to the data shown in FIG. 4 and the input will be loud enough to be consistent with normal speech. This second criteria is tested by comparing the input data to a preselected threshold value. Data which does not exceed the threshold is presumed to not be speech and will not be used as the basis for selecting an input device. FIG. 5 illustrates data which exhibits significant variation above the background noise, but which fails to meet the threshold 502.

The threshold value may be a single fixed level, as illustrated or may be an incremental value above the measured background noise. Both approaches give similar results where a single background value is used. Where separate background levels are used for each input device, the use of separate thresholds determined as an incremental amount above the background level may provide improved identification of the best device to use in situations such as a person who is speaking quietly because they are in a quiet area. In this case the sample data may not meet a higher, fixed level.

Referring again to FIG. 6 step 604 terminates when sufficient data has been collected. This may be a predefined quantity of data, predefined sampling period, or may be determined dynamically such as by analyzing the data to identify a data set which is significantly more variable and meets all criteria. Two or more techniques may also be combined such as by setting an maximum time limit on a dynamic method. In an exemplary embodiment the sampled data is tested 606 against the threshold 302, 402, 502 and any samples which do not meet the threshold are discarded. The remaining samples are individually analyzed to determine the background noise value 608 and then the deviations above the background level are calculated 610. In another exemplary embodiment all audio samples are analyzed 608 to determine their peak value and the threshold checked as part of determining the sample having the greatest deviation 610. A first exemplary embodiment uses the maximum deviation above the background level as the deviation value. A second exemplary embodiment uses the average deviation above the background level as the deviation value. These and other methods of calculating the deviation value are anticipated and are considered within the present disclosure.

With the deviation values calculated, that input device having the greatest deviation above the background noise is selected 612. All other microphones are deactivated 614 and all future input is accepted from the selected microphone. If none of the sampled data meets all of the criteria a preselected default microphone will be used. If the data from more than one microphone satisfies all criteria and are within a preselected relative range from each other, they will be considered equal and a preconfigured rule will be applied to select the correct device.

In an exemplary embodiment, dBm level is used as a simplification to represent the input signals. Thus the test on a single microphone A becomes:

dBm(A)>B_{A}+T_{A}

Where dBm(A) is the peak input level, B_{A} is the background level, and T_{A} is the threshold level. T_{A} is based on standard deviation in samples obtained from microphone A used in calculation of B_{A}. If this test is satisfied, then microphone A is a candidate for selection. It's peak level is compared to all other microphones which also pass this test and the one with the largest peak input is selected.

If one or more of the microphones, e.g., B, cannot be sampled, then a preselected background value which approximates white noise W_{B} is used for B with no peaks. This approach has more inherent error so a larger threshold value T_{A}′ is used. In the above exemplary embodiment the test becomes:

If dBm(A)>W_{A}+T_{A}′, then select A.

During the initial sampling period an exemplary embodiment will route audio output to all available output devices so that the user can hear the output no matter which device they are using. After the input device has been selected, an output device which has been predetermined to correspond to that input device will be selected and all other output devices deactivated.

In the above exemplary embodiments sampling is performed during a short period at the initiation of a call. Another embodiment periodically samples the microphones while the system is not active. This allows the correct microphone to be known immediately at the start of the call or other system activation. In this context “active” is understood as the system being used for its intended purpose. While inactive, the system is still functional and capable of performing the necessary processing. Yet another embodiment periodically samples the input levels during the call or other use of the system. This allows for adapting to changes in the situation. For example, the user could start a call using speakerphone and then put on a wireless headset and walk away from the base unit. The system would detect that the headset has become a better source and switch to the headset, deactivating the speakerphone.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It will be understood by those skilled in the art that many changes in construction and widely differing embodiments and applications will suggest themselves without departing from the scope of the disclosed subject matter.

What is claimed is:

1) A method of selecting an audio input device for use by a system having a plurality of audio input devices, the method comprising:
(a) detecting an activation of the system;
(b) responding to the activation of the system by obtaining an audio sample from each of the plurality of audio input devices;
(c) determining a background sound level from the audio input samples;
(d) determining a peak deviation of sound level above the background sound level for each of the audio input samples; and
(e) selecting for use the audio input device from which an audio input sample having a greatest deviation above the background sound level was obtained.

2) The method of claim 1 further comprising deactivating all audio input devices not selected for use.

3) The method of claim 1 wherein the background sound level is a common value determined from all audio input samples.

4) The method of claim 1 wherein the background sound level is a distinct value for each audio input device, determined from the audio input sample obtained from each of the plurality of audio input devices.

5) The method of claim 1 wherein the system comprises a plurality of audio output devices, one associated with each of the plurality of audio input devices and the method comprises selecting for use an audio output device associated with the audio input device which is selected for use.

6) The method of claim 5 wherein an audio output is routed to each of the plurality of audio output devices until the audio output device is selected for use.

7) The method of claim 1 wherein the step of selecting for use the audio input device having the greatest deviation comprises excluding from consideration all audio input devices for which the audio input sample obtained from that audio input device has a peak value which does not meet a predetermined threshold level.

8) The method of claim 7 wherein if the step of excluding from consideration all the audio input devices which do not meet the predetermined threshold level eliminates all audio input devices, further comprises selecting by default a preselected device.

9) The method of claim 1 further comprising obtaining a new audio input sample from each audio input device at a time after selecting for use the audio input device, determining a second background sound level from the new audio input sample, determining a new peak deviation value for each of the plurality of audio input devices, and selecting for use a different audio input device having the new peak deviation value greater than that for the audio input device initially selected for use.

10) A method of selecting an audio input device for use in a system, the method comprising:
(a) monitoring a plurality of audio input devices for a time period;
(b) determining a background sound level for each of the plurality of audio input devices;
(c) determining a peak deviation value for each of the plurality of audio input devices, the peak deviation value representing an amount by which peak sound level exceeds the background sound level; and
(d) selecting for use an audio input device having a greatest peak deviation value.

11) The method of claim 10 wherein the peak sound level is determined as an average of all peak values detected during the time period.

12) The method of claim 10 wherein the time period for monitoring begins prior to an activation of the system comprising the plurality of audio input devices and the step of selecting for use the audio input device begins after the activation of the system.

13) The method of claim 10 wherein the time period for monitoring begins upon activation of the system and continues for a fixed time period.

14) The method of claim 10 wherein the time period for monitoring begins upon activation of the system and continues for a variable time until a sufficient data has been obtained to select the audio input device for use; and the steps of determining the background sound level and determining the peak deviation value occur continually during monitoring.

15) The method of claim 10 wherein each of the plurality of audio input devices has an associated audio output device and selecting for use an audio output device associated with the audio input device selected.

16) The method of claim 15 further comprising deactivating each of the plurality of audio input devices and each of the plurality of audio output devices not selected for use.

17) Where a plurality of audio input devices are available for use by a system, a method for selecting one of the plurality of audio input devices upon an activation of the system, the method comprising:
(a) monitoring the plurality of audio input devices for a time period;
(b) determining a background sound level;
(c) determining a peak deviation value for each of the plurality of audio input devices, the peak deviation value representing an amount by which peak sound level exceeds the background sound level;
(d) comparing the peak deviation values to a preselected threshold value;
(e) responding to the activation of the system by selecting for use an audio input device having a greatest peak deviation value which also exceeds the preselected threshold value; and
(f) deactivating each of the plurality of audio input devices available not selected for use.

18) The method of claim 17 wherein monitoring ends upon the activation of the system and determining the background sound level begins immediately after the activation of the system.

19) The method of claim 17 wherein monitoring begins upon the activation of the system.

20) The method of claim 17 further comprising periodic monitoring while the system is active, each monitoring period comprising re-activating the plurality of audio input devices, newly determining the background sound level; newly determining the peak deviation values for each of the plurality of audio input devices, and selecting a different audio input device for use on a basis of superior peak deviation values.
